(19) United States
(12) Patent Application Publication
(10) Pub. No.: US 2016/0348417 A1
(43) Pub. Date: Dec. 1, 2016

(54) COVERING ASSEMBLY FOR BUILDING OPENING

(71) Applicant: NIEN MADE ENTERPRISE CO., LTD., Taichung City (TW)

(72) Inventor: Keng-Hao NIEN, Taichung City (TW)

(21) Appl. No.: 15/165,852

(22) Filed: May 26, 2016

(30) Foreign Application Priority Data
May 26, 2015 (CN) 201520345848.8

(51) Int. Cl. E06B 3/26; E06B 9/262; E06B 3/263; E06B 9/04

(52) U.S. Cl. CPC E06B 3/2605; E06B 9/04; E06B 9/262; E06B 3/263; E06B 2009/2627

(57) ABSTRACT

A covering assembly for a building opening is disclosed, which includes a first frame and a second frame with one in front of the other. The first frame has a first shield structure provided thereon to shade or open a surrounded opening of the first frame, and the second frame has a second shield structure provided thereon to shade or open a surrounded opening of the second frame. The first frame further has a first positioning structure, and the second frame has a second positioning structure, wherein the second positioning structure and the first positioning structure are mortised together, so that the first frame and the second frame could be quickly aligned with each other and mortised together while installing.

The current application claims a foreign priority to application number 201520345848.8 filed on May 26, 2015 in China.

### BACKGROUND OF THE INVENTION

1. Technical Field

The present invention generally relates to closure constructions, and more particularly to a covering assembly for a building opening.

2. Description of Related Art

It is well-known that building openings, such as windows, are usually installed with movable closure constructions for the purpose of shading, ventilation, protecting personal privacy, etc. Commonly seen closure constructions include shutters, blinds, Roman shades, and cellular shades, which are selected and installed based on the using environments and requirements. Said closure constructions not only provide specific functions, but also are decorative.

However, in the case of special or particular requirements, two different types of closure constructions may be installed at one building opening at the same time, with one in front of the other. In practice, while installing two completely different types of closure constructions, it is usually disturbing to effectively and precisely align two frames. Therefore, if such problem could be solved, the working efficiency would be improved.

### BRIEF SUMMARY OF THE INVENTION

In view of the reasons mentioned above, the primary objective of the present invention is to provide a covering assembly for a building opening, which provides good shading effect, and improves the working efficiency.

The present invention provides a covering assembly for a building opening, which includes a first frame, a first shield structure, a second frame, and a second shield structure. The first frame includes a first frame piece, wherein a first positioning structure is provided on a lateral side of the first frame piece. The first shield structure is connected to the first frame, wherein the first shield structure is adapted to shade or open a surrounded opening of the first frame. The second frame includes a second frame piece, wherein a second positioning structure is provided on a lateral side of the second frame piece; the second positioning structure and the first positioning structure are mortised together to align and mortise the first frame and the second frame. The second shield structure is connected to the second frame, wherein the second shield structure is adapted to shade or open a surrounded opening of the second frame.

In an embodiment, the first positioning structure of the first frame piece comprises a groove, which is recessed along a long edge of the first frame piece; the second positioning structure of the second frame piece comprises a tongue, which is projected along a long edge of the second frame piece, and is embedded into the groove.

In an embodiment, the second frame piece further has a barrier plate provided on a side thereof which is away from the second positioning structure; the barrier plate extends toward the surrounded opening of the second frame, so that an edge of the second shield structure is located between the barrier plate and the first frame piece.

In an embodiment, the first frame comprises a plurality of perforations, each of which is passed through by one of a plurality of bolts; the bolts are fastened on the building.

In an embodiment, the covering assembly further includes at least one cover, which joints the first frame to cover the bolts.

With the first and the second positioning structures, the first and the second frames could be quickly and precisely aligned with each other and mortised together.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is an exploded view of the preferred embodiment of the present invention mentioned above;

FIG. 3 is a perspective view of the first frame piece and the second frame piece of the preferred embodiment of the present invention mentioned above;

FIG. 4 is a sectional view, showing the first frame piece and the second frame piece are aligned with each other and mortised together;

FIG. 5 is a sectional view, showing the composite structure composed of the first frame and the second frame is installed on the outer side of the wall of the building;

FIG. 6 is a perspective view, showing the relation between the cover and the first frame; and

FIG. 7 is a sectional view, showing the composite structure composed of the first frame and the second frame is embedded into the building opening.

### DETAILED DESCRIPTION OF THE INVENTION

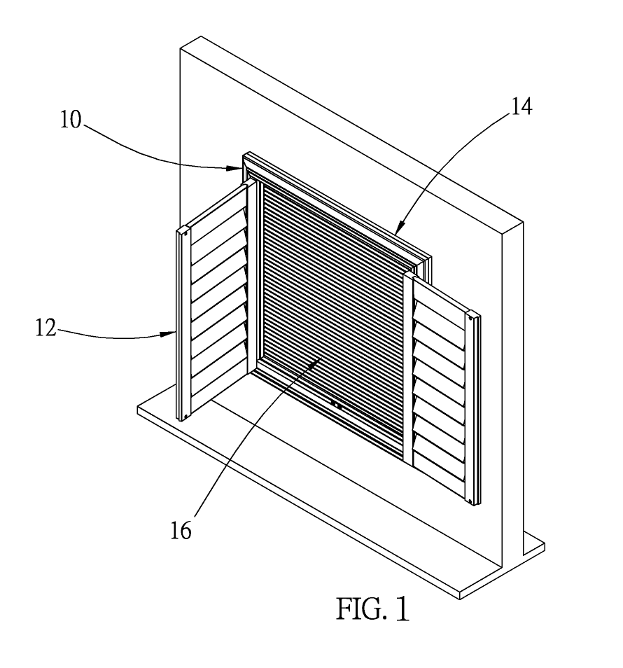

A covering assembly for a building opening of the preferred embodiment of the present invention is illustrated in FIG. 1. Said building opening is adapted to ventilate, and to allow light entering the building. A closure construction is used to cover the building opening, wherein the closure construction is decorative, and could be a shutter, a blind, a Roman shade, a cellular shade, etc. In the current preferred embodiment, the closure construction refers to a composite structure composed of two different types of closure constructions.

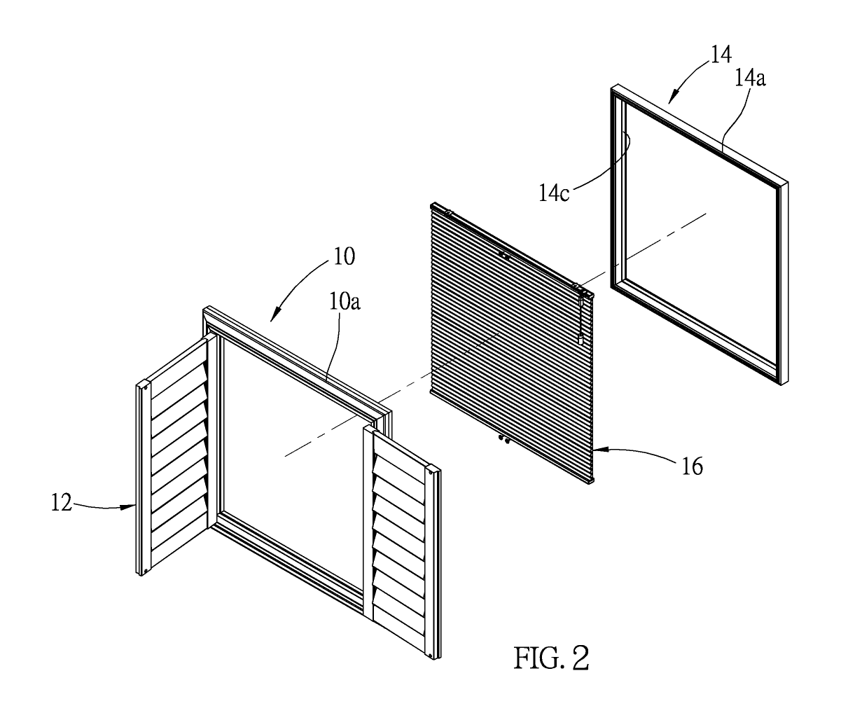

As shown in FIG. 2, the covering assembly of the current preferred embodiment includes a first frame 10, a first shield structure 12, a second frame 14, and a second shield structure 16. The first frame 10 includes a plurality of first frame pieces 10a, which together form a rectangular frame body. Similarly, the second frame 14 also includes a plurality of second frame pieces 14a, which together form a rectangular frame body as well. The first frame 10 and the second frame 14 are equal in size.

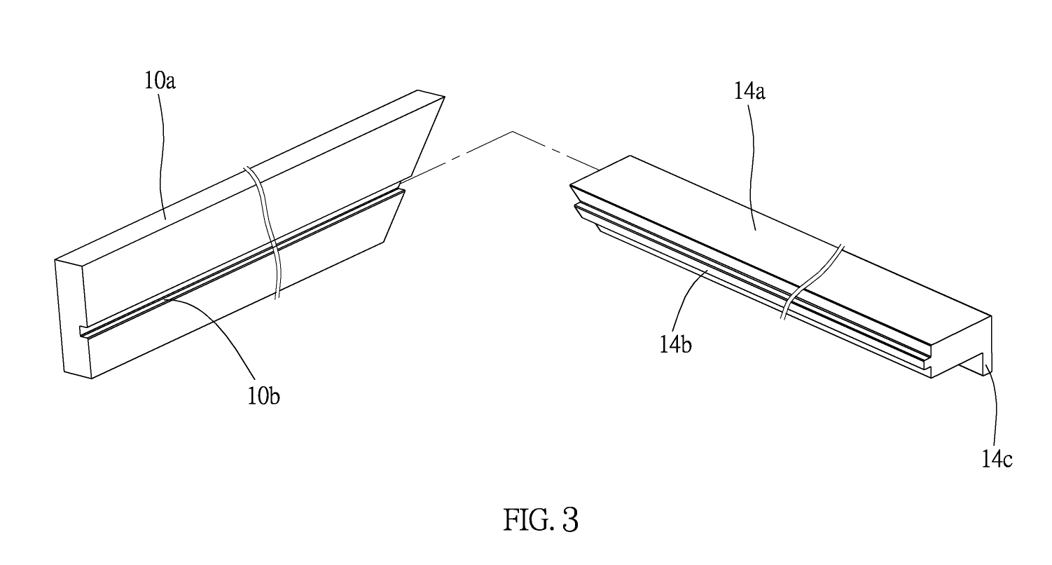

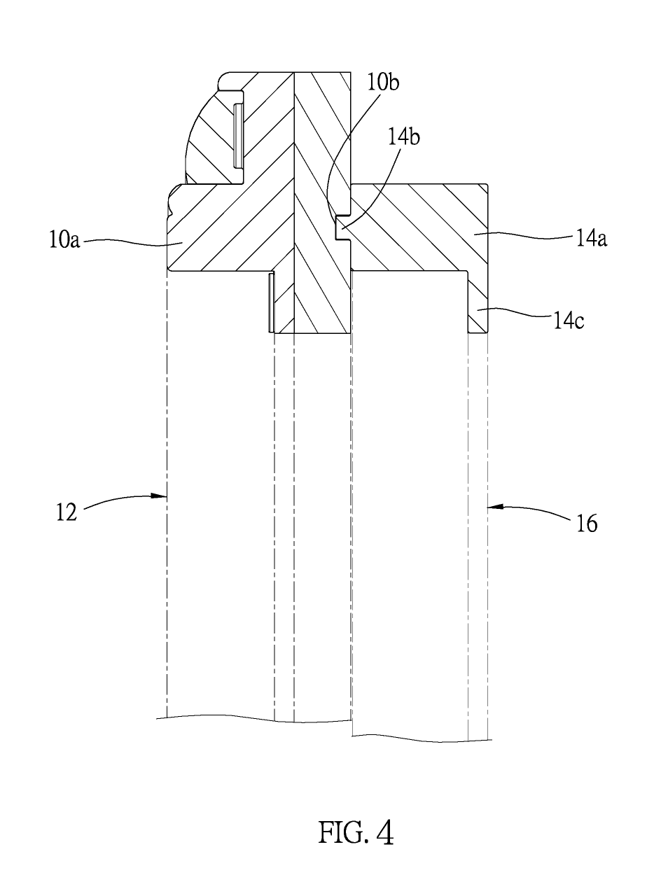

As shown in FIG. 3, the first frame 10 of the current preferred embodiment has a first positioning structure, which is a groove 10b recessed into a lateral surface along a long edge of each of the first frame pieces 10a. Correspondingly, the second frame 14 has a second positioning structure, which is a tongue 14b projected from a lateral surface along a long edge of each of the second frame pieces 14a. As shown in FIG. 4, the groove 10b and the tongue 14b have identical and matching sectional shapes, so that the first frame 10 and the second frame 14 could be quickly and precisely aligned with each other and mortised together. As a result, the working efficiency would be improved, and the first frame 10 and the second frame 14 could be ensured to align properly without any shifting or biasing. The sectional shape of the aforementioned groove 10b and tongue 14b is a roughly U shape; however, in practice, other shapes (e.g., V-shape) are not excluded, as long as the aligning effect could be achieved. In other words, equivalent structures employing the same concepts should be considered falling within the scope of the present invention.

In addition, the groove 10b and the tongue 14b are respectively provided along a peripheral edge of the corresponding frame body, and therefore each forms a rectangle; however, in practice, the groove could be only provided on one of the frame pieces 10a of the first frame 10 on a side thereof, and the tongue could be correspondingly provided on one of the frame pieces 14a of the second frame 14. In this way, a length of the groove and a length of the tongue are both shortened, which could also provide the same effect of quick alignment while installing. Also, each of the second frame pieces 14a of the second frame 14 further has a barrier plate 14c on a side away from the tongue 14b, i.e., the second positioning structure, wherein each of the barrier plate 14c extends toward a surrounded opening of the second frame 14.

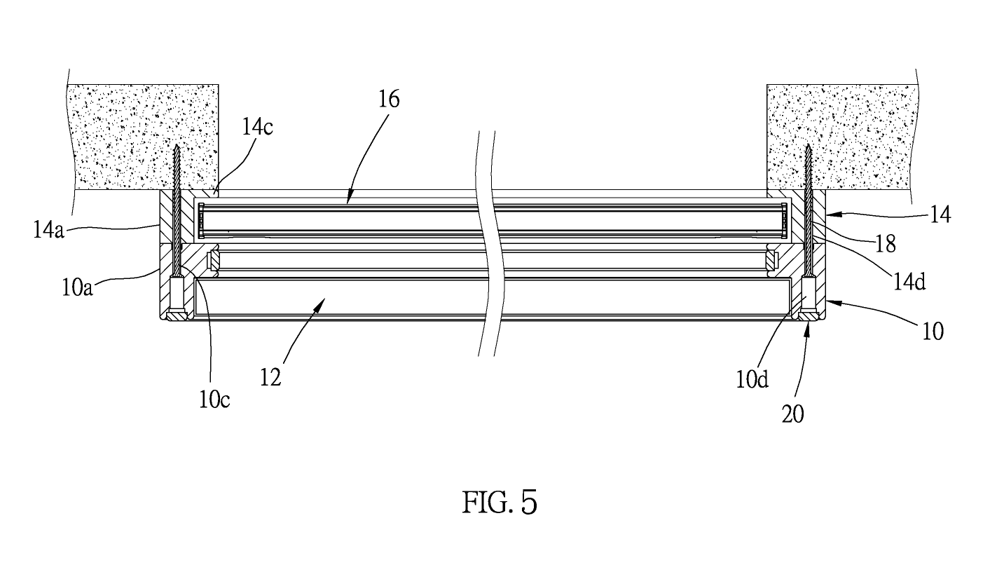

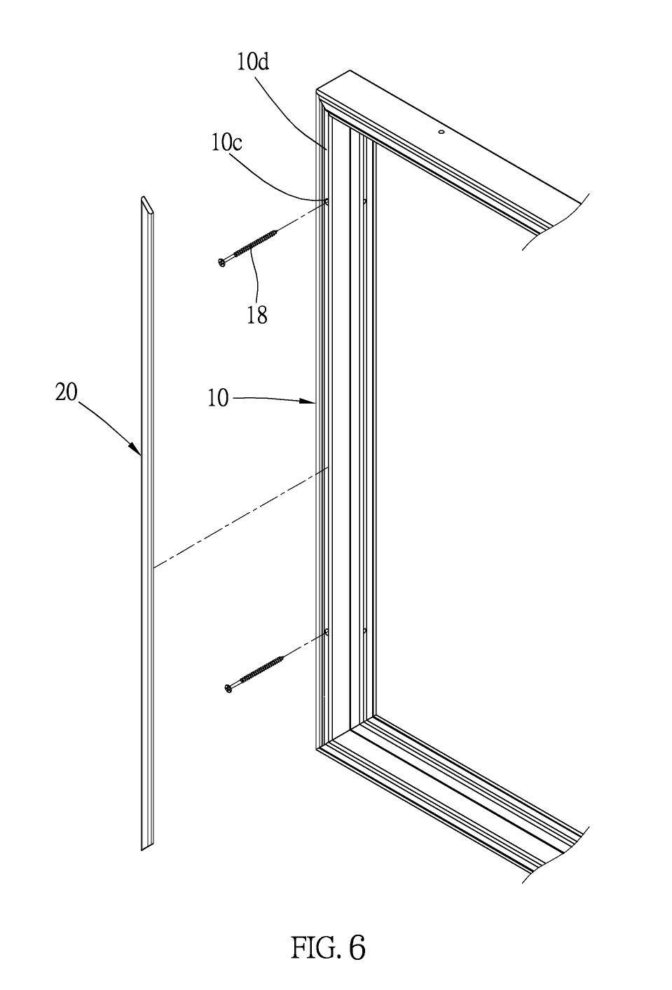

As shown in FIG. 5, once the alignment and the mortise-and-tenon jointing is done, the composite structure composed of the first frame 10 and the second frame 14 is fixed and installed onto the wall of the building through a plurality of bolts 18. In the aforementioned preferred embodiment, the composite structure composed of the first frame 10 and the second frame 14 is installed on an outer side of the wall of the building, wherein the bolts 18, in a direction perpendicular to the wall, sequentially pass through perforations 10c on the groove 10b of the first frame 10 and perforations 14d on the tongue 14b of the second frame 14, and then go into the wall. As shown in FIG. 6, the first frame 10 has a long slot 10d provided on a lateral surface opposite to the groove 10b, wherein an end of each of the perforations 10c communicates with the long slot 10d. A long cover 20 is provided in the long slot 10d, wherein the cover 20 is not only decorative, but also adapted to cover the bolts 18. Of course, the cover 20 could also be devised to have a shape corresponding to the perforations 10c, and in such a case, part of the cover 20 could be directly embedded into the perforations 10c to cover the bolts 18.

After the first frame 10 and the second frame 14 are mortised together and are installed at the opening of the building, the first shield structure 12 and the second shield structure 16 are then installed at one of the frames, respectively. The first shield structure 12 is connected to the first frame 10 in a way that the first shield structure 12 could open or shade the surrounded opening of the first frame 10. Similarly, the second shield structure 16 is connected to the second frame 14 in a way that the second shield structure 16 could open or shade the surrounded opening of the second frame 14. As it can be seen in FIG. 5, each edge of the second shield structure 16 is located between one of the first frame pieces 10a and one of the barrier plates 14c, so that the barrier plates 14c could shade the gap formed between the second shield structure 16 and the second frame pieces 14a. When the second shield structure 16 is extended, light would not leak into the room through the gaps between the second shield structure 16 and the second frame pieces 14a. In the current preferred embodiment, the first shield structure 12 is a shutter as an example, while the second shield structure 16 is a cellular shade as an example, wherein the shutter has two corresponding sashes, which are pivotally provided on one of the vertical first frame pieces 10a of the first frame 10 in a symmetric way; as for the cellular shade, it is installed on the upper horizontal second frame piece 14a of the second frame 14, and is adapted to be extended or raised in a vertical direction.

After completing the installation, the shutter faces the room, while the cellular shade is located behind the shutter. The shutter and the cellular shade provide different visual feelings, for they have completely different structures. Furthermore, while in use, a fully extended cellular shade could prevent light from leaking into the room through the gaps between the slats of the shutter. In other words, such design could provide even better effect of shading light, whereby light could be completely blocked out.

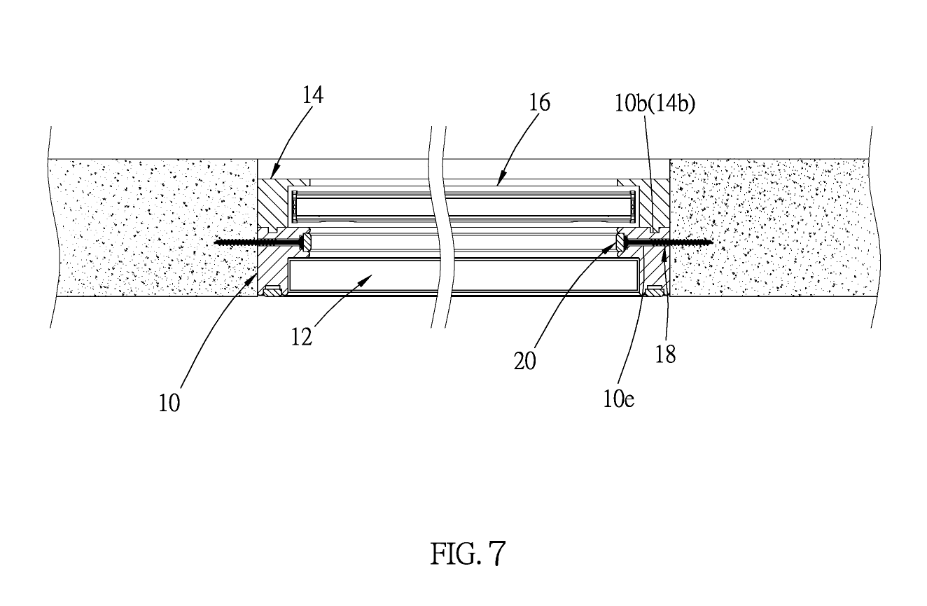

An alternative preferred embodiment is illustrated in FIG. 7, and the differences between it and the previous preferred embodiment are that, a composite structure composed of a first frame 10 and a second frame 14 of the current preferred embodiment is directly embedded into the opening of the building. Since the first frame 10 and the second frame 14 are mortised together through a groove 10b and a tongue 14b, the composite structure composed of the first frame 10 and the second frame 14 could be firmly installed on the building by simply making bolts 18 pass through perforations 10e of the first frame 10 and go into the wall. Similarly, a long cover 20 could be embedded into each of long slots located on an inner side of the first frame 10 to decorate and to cover the bolts 18. Also, decorative sidebars could be further provided on a side of the first frame 10 opposite to the second frame 14 to meet different requirements; the junctions between the opening of the building and the first frame 10 could be decorated in this way.

It must be pointed out that the embodiments described above are only some preferred embodiments of the present invention. All equivalent structures which employ the concepts disclosed in this specification and the appended claims should fall within the scope of the present invention.

What is claimed is:

1. A covering assembly for a building opening, comprising:
a first frame comprising a first frame piece, wherein a first positioning structure is provided on a lateral side of the first frame piece;
a first shield structure connected to the first frame, wherein the first shield structure is adapted to shade or open a surrounded opening of the first frame;
a second frame comprising a second frame piece, wherein a second positioning structure is provided on a lateral side of the second frame piece; the second positioning structure and the first positioning structure are mortised together to align and mortise the first frame and the second frame; and
a second shield structure connected to the second frame, wherein the second shield structure is adapted to shade or open a surrounded opening of the second frame.

2. The covering assembly of claim 1, wherein the first positioning structure of the first frame piece comprises a groove, which is recessed along a long edge of the first frame piece; the second positioning structure of the second frame piece comprises a tongue, which is projected along a long edge of the second frame piece, and is embedded into the groove.

3. The covering assembly of claim 2, wherein the second frame piece further has a barrier plate provided on a side thereof which is away from the second positioning structure; the barrier plate extends toward the surrounded opening of the second frame, so that an edge of the second shield structure is located between the barrier plate and the first frame piece.

4. The covering assembly of claim 2, wherein the first frame comprises a plurality of perforations, each of which is passed through by one of a plurality of bolts; the bolts are fastened on the building.

5. The covering assembly of claim 4, further comprising at least one cover, which joints the first frame to cover the bolts.
